(19) United States
(12) Patent Application Publication
(10) Pub. No.: US 2011/0128350 A1
(43) Pub. Date: Jun. 2, 2011

(54) METHOD AND APPARATUS FOR CHOOSING A DESIRED FIELD OF VIEW FROM A WIDE-ANGLE IMAGE OR VIDEO

(75) Inventors: Manuel Oliver, Scottsdale, AZ (US); Joseph W. Bostaph, Chandler, AZ (US); Daniel J. Sadler, Gilbert, AZ (US)

(73) Assignee: MOTOROLA, INC., Schaumburg, IL (US)

(21) Appl. No.: 12/627,331

(22) Filed: Nov. 30, 2009

(51) Int. Cl. G06K 9/48; H04N 7/00; H04N 5/228

(52) U.S. Cl. 348/36; 382/199; 348/208.5; 348/E05.055; 348/E05.03

(57) ABSTRACT

A wide-angle camera will collect wide-angle images. A portion of the wide-angle image (desired field of view) will be selected based on accelerometer readings. More particularly, to keep the desired field of view of a camera in an appropriate position, a correction is made to the tilt and roll of the desired field of view by using motion sensors to determine the horizon based on measuring the direction of gravity. A correction is also made to the yaw of the desired field of view using motion sensors to determine a forward facing position when the user is in motion. Because the desired field of view is corrected for variations resulting from user activity, any image collected from the camera is more likely to be pointed at a desired position.

### FIELD OF THE INVENTION

The present invention relates generally to a method and apparatus for choosing a desired field of view from a wide-angle image or video, and in particular, to a method and apparatus for choosing a desired field of view from a wide-angle wearable camera.

### BACKGROUND OF THE INVENTION

Wearable cameras are being deployed on law enforcement personnel to help capture video evidence. These cameras, which are typically mounted at the temple, shoulder, or chest, are subject to field-of-view variations due to deviations in mounting the camera. Additionally, user activity can result in field-of-view variations. Variations in the field of view of the camera can have the unintended result of shifting the field of view of the camera away from a desired position (e.g., pointing in front of the wearer) resulting in important video images being missed or only partially captured. Therefore, a need exists for a method and apparatus for choosing a desired field of view from an image, and in particular for choosing a desired field of view from a wearable camera.

### BRIEF DESCRIPTION OF THE DRAWINGS

FIG. 1 illustrates a wearable camera.

FIG. 2 illustrates a desired field of view taken from a wide-angle image.

FIG. 3 is a block diagram of a camera.

FIG. 4 illustrates a properly-oriented camera and a camera that is not properly oriented.

FIG. 5 illustrates choosing a desired field of view from an improperly-oriented camera.

FIG. 6 illustrates a desired field of view from a properly-oriented camera.

FIG. 7 illustrates a cropped image taken from an improperly-oriented camera.

FIG. 8 shows an image created on the image sensor using a lens.

FIG. 9 illustrates an image projected onto an image sensor.

FIG. 10 illustrates

FIG. 11 illustrates a cropped image taken from an improperly-oriented camera.

FIG. 12 is a flow chart showing the operation of the camera of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for choosing a desired field of view from a wide-angle image or video is provided herein. During operation, a wide-angle camera will collect wide-angle images. A portion of the wide-angle image (desired field of view) will be selected based on accelerometer readings. More particularly, to keep a desired field of view of a camera in the appropriate position, a correction is made to the tilt and roll of the desired field of view by using motion sensors to determine the horizon based on measuring the direction of gravity. A correction is also made to the yaw of the desired field of view using motion sensors to determine the forward facing position when the user is in motion. Because the desired field of view is corrected for variations resulting from user activity, any image collected from the camera is more likely to be pointed at a desired position.

The present invention encompasses a method for choosing a desired field of view from image or video. The method comprises the steps of collecting an image or video from image collecting circuitry, determining a direction of motion from an accelerometer, and choosing the desired field of view from the image or video based on the direction of motion determined from the accelerometer.

The present invention additionally encompasses a method for choosing a desired field of view from image or video. The method comprises the steps of collecting an image or video from wide-angle image collecting circuitry having a first field of view, determining a direction of motion from an accelerometer, and determining a direction of gravity from the accelerometer. Finally, a desired field of view is chosen from the image or video based on the direction of motion and the direction of gravity determined from the accelerometer. The desired field of view is smaller than the first field of view.

Finally, the present invention encompasses an apparatus for choosing a desired field of view from image or video. The apparatus comprises image collecting circuitry collecting an image or video, and logic circuitry determining a direction of motion from an accelerometer and choosing the desired field of view from the image or video based on the direction of motion determined from the accelerometer.

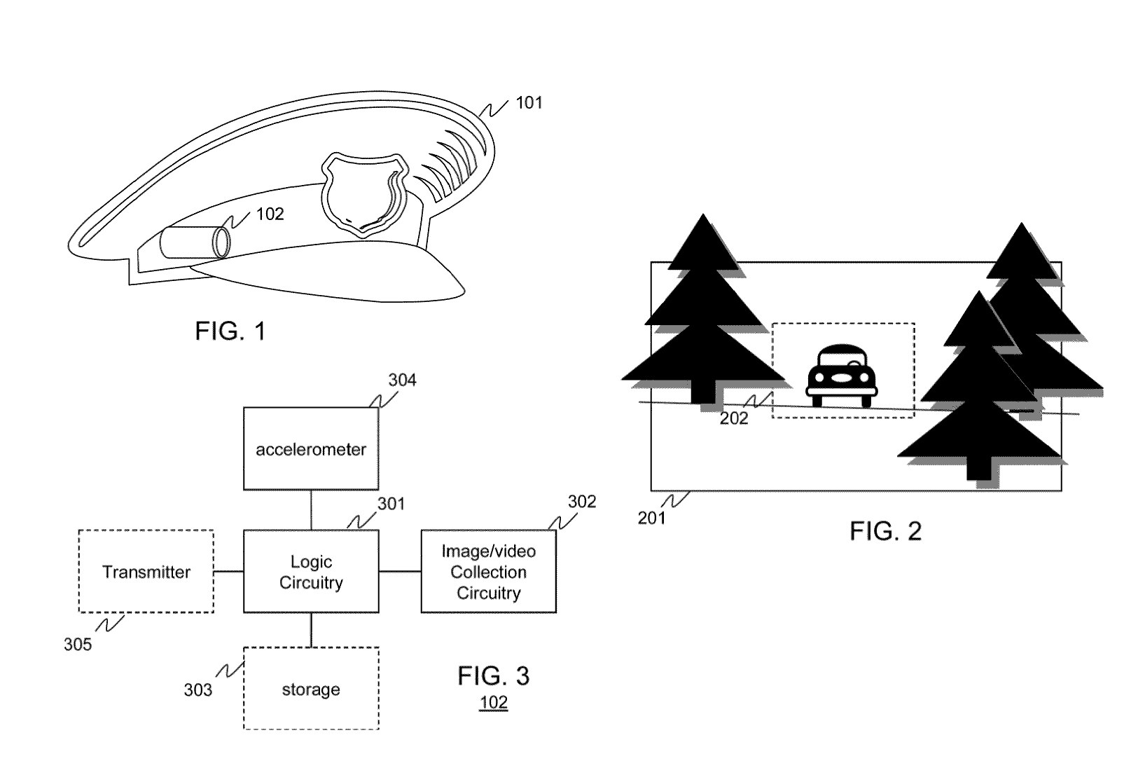

Turning now to the drawings, where like numerals designate like components, FIG. 1 is a block diagram showing camera 102 mounted to hat 101. Camera 102 preferably contains a wide field of view projection lens (e.g. 110 degrees) or a “fisheye” lens capable of capturing an extremely wide, hemispherical image (e.g., 180 degrees). Although camera 102 is shown mounted to hat 101, in other embodiments of the present invention camera 102 may be mounted to the shoulder or chest of a wearer. Camera 102 serves to capture a wide-angle image or video (e.g. 1920×1080 at 30 frames/second) of its surroundings and then output a desired portion (cropped portion, or also referred to as the desired field of view) of the captured image or video at a particular resolution (e.g., 640×480 8-bit pixels at 30 frames/second). The desired portion may then be compressed, stored, transmitted, or displayed.

For example, the desired portion may be wirelessly transmitted to a dispatch center where it may be viewed in real time or stored as evidence. Similarly, the desired portion may be output to local storage where it may be later retrieved.

Capturing only a portion of the wide angle image (typically a 40-60 degree horizontal field of view) serves to increase resolving power for 640×480 images output from camera 102. For example there is a 3-4× reduction in the horizontal linear resolution of the wide angle image (e.g. 180 degree horizontal field of view) when compared to an image having a 50 degree horizontal field of view. For evidentiary purposes it is desirable to capture sufficient resolution in the scene to be able to clearly identify objects (e.g. weapons) or people of interest.

FIG. 2 illustrates a desired image 202 taken from a wide-angle image 201. As is evident, for images output at a specific resolution (e.g., 640×480), desired image 202 has a much narrower field of view and better resolving power than wide-angle image 201 would have at the same specific resolution (640×480).

FIG. 3 is a block diagram of wearable camera 102. As shown, camera 102 comprises logic circuitry 301, image or video collection circuitry 302, optional storage 303, and three-axis accelerometer 304. Collection circuitry 302 comprises a standard wide field of view lens, and a charge-coupled device (CCD) or complementary metal-oxide-semiconductor (CMOS) image sensor capable of outputting images or video at a particular resolution.

Logic circuitry 301 comprises a digital signal processor (DSP), general purpose microprocessor, a programmable logic device, or application specific integrated circuit (ASIC) and is utilized to accesses and control collection circuitry 302, to select a desirable field of view from images or video fed to it from circuitry 302, and to output the desired field of view. The desired field of view can be stored, transmitted, or both.

Optional storage 303 comprises standard random access memory or flash memory and is used to store the desired field of view selected by logic circuitry 301. It should be noted that storage 303 may exist internal to, or external to camera 102.

Accelerometer 304 comprises a standard micro machined accelerometer used to measure a proper acceleration it experiences relative to freefall. Preferably, accelerometer 304 comprises a multi-axis accelerometer that is capable of detecting magnitude and direction of acceleration as a vector quantity, and can be used to sense orientation, vibration, motion and shock.

Finally, transmitter 305 comprises common circuitry known in the art for communication utilizing a well known communication protocol, and serve as means for transmitting images or video. Possible transmitters include, but are not limited to transmitters utilizing Bluetooth, IEEE 802.11, or HyperLAN protocols, or any cellular communication system protocol (e.g., CDMA, TDMA, GSM, WCDMA, . . . , etc.).

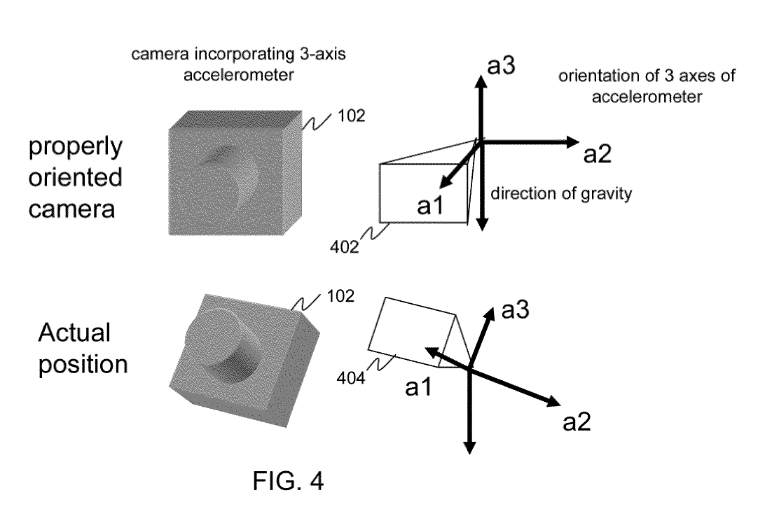

As discussed above, wearable cameras are subject to field-of-view variations due to deviations in mounting the camera or user activity. Variations in the field of view of the camera can have the unintended result of shifting the field of view of the camera away from a desired position (e.g., pointing in front of the wearer) resulting in important video images being missed or only partially captured. This is illustrated in FIG. 4.

As shown in FIG. 4, properly oriented camera 102 is pointing in directional, which is perpendicular to the direction of gravity, and directly along a path of motion. This results in desired image 402 being properly captured. However, an actual position of camera 102 may be skewed. This results in camera 102 pointing in directional, which is not perpendicular to the direction of gravity, and not along a path of motion. In addition, a3 is no longer parallel to the direction of gravity. This results in cropped image 404 being improperly captured.

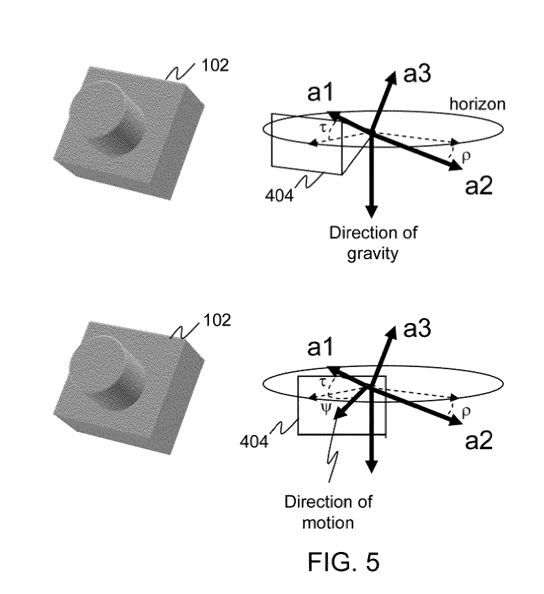

In order to correct the improper alignment of camera 102 a desired field of view will be selected based on accelerometer 304 readings. More particularly, to select the desired field of view of camera 102, a correction is made by logic circuitry 301 to the tilt and roll of field 404 by using accelerometer 304 to determine the horizon based on measuring the direction of gravity. The tilt correction is given by τ, the angular difference between a1 and the horizon, where a1 is a direction that the camera is pointing. The roll correction is given by ρ, the angular difference between a2 and the horizon, where a2 is a direction perpendicular to a1. Ideally, both a1 and a2 are perpendicular to the direction of gravity. This is illustrated in FIG. 5 where field 404 is first positioned with both a1 and a2 perpendicular to the direction of gravity.

A correction ψ is also made to the yaw of field of view 404 using accelerometer 304 to determine the forward facing position when the user is in motion (e.g., walks or runs). In particular, field of view 404 is positioned to point parallel the direction of motion. Because the desired field of view is adjusted to point perpendicular to the direction of gravity, and parallel to the direction of motion, any image collected from the camera is more likely to be pointed at a desired position.

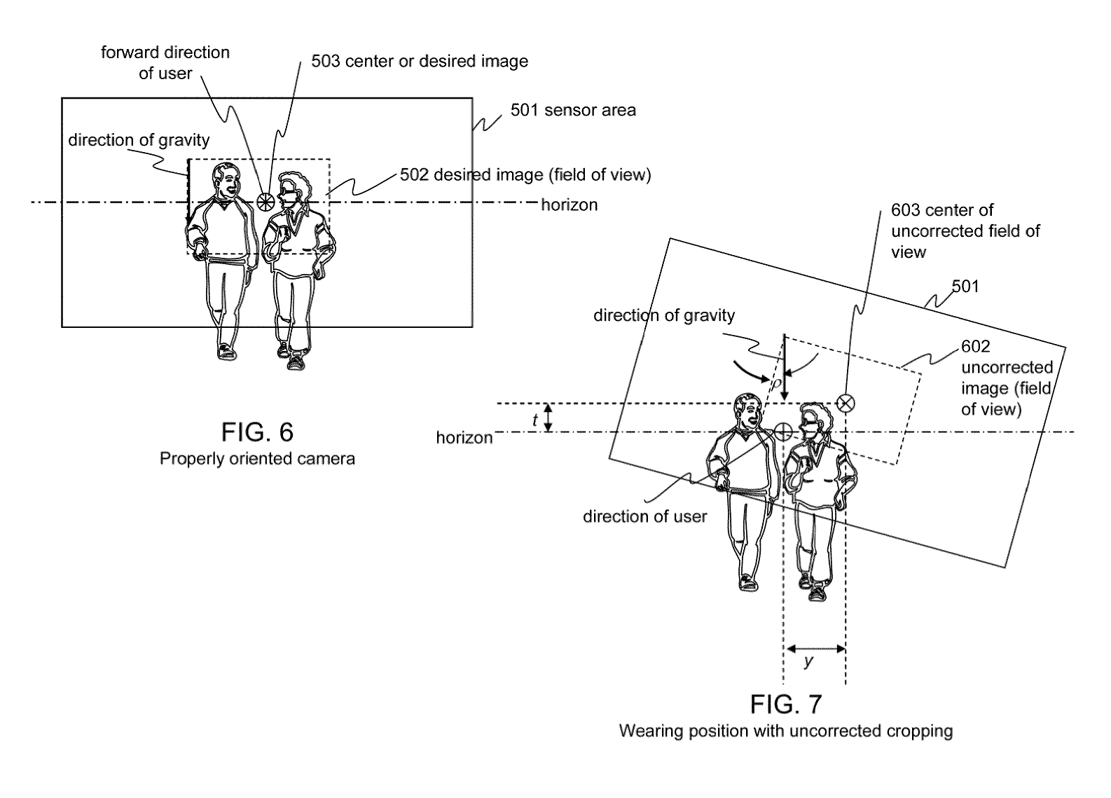

The above technique is further illustrated with reference to FIGS. 6 through 12. FIG. 6 illustrates desired field of view 502 from a properly-oriented camera. More specifically, proper orientation is characterized by three features: (1) the vertical edge of the desired field of view 502 is aligned with the direction of gravity; (2) the center of the desired field of view 503 lies on the horizon; and (3) the center of the desired field of view 503 is aligned with the forward direction of the user. There may be some situations where these might be modified. For example, if the user is wearing the camera at the waist it might be desirable to set the center of the desired image at an angle above the horizon. As shown in FIG. 6, the camera is moving towards two individuals. However, as discussed above, the camera may be aligned improperly. This is illustrated in FIG. 7.

In FIG. 7 the three features that characterize proper alignment are no longer satisfied. In particular, the vertical edge of the uncorrected field of view 602 is no longer aligned with the direction of gravity and is characterized by a roll angle, ρ. This roll angle ρ is the same roll angle illustrated in FIG. 5. Also the center of the uncorrected field of view 603 lies above the horizon by a distance t on the image sensor, and differs from the forward direction of the user by a distance y on the image sensor. The distance t is related to angle τ showed in FIG. 5. The distance y is related to angle ψ in FIG. 5. These relationships are explained below.

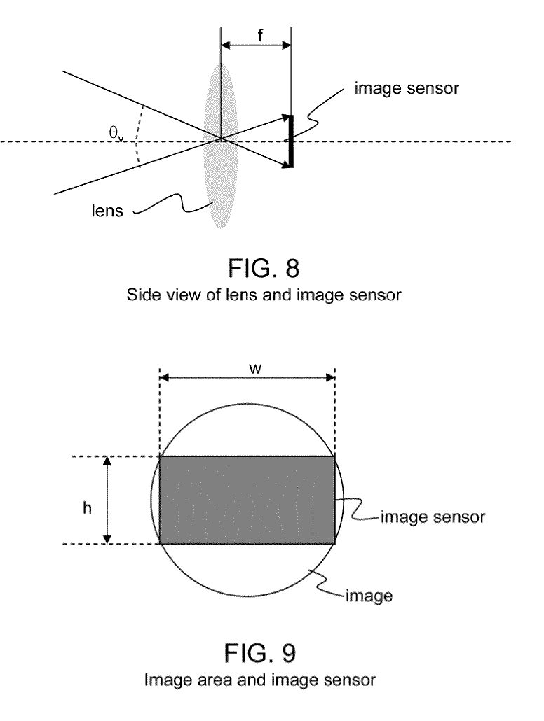

The image is created on the image sensor using a lens as shown in FIG. 8, The image sensor is placed at the focal length of the lens, f. Also shown in FIG. 8 is θᵥ, the vertical angle of view that is captured on the image sensor. In a similar fashion but not illustrated in FIG. 8, a horizontal angle of view θₕ is also captured on the image sensor. These angles θᵥ and θₕ are typically not the same but depend on dimensions of the image sensor.

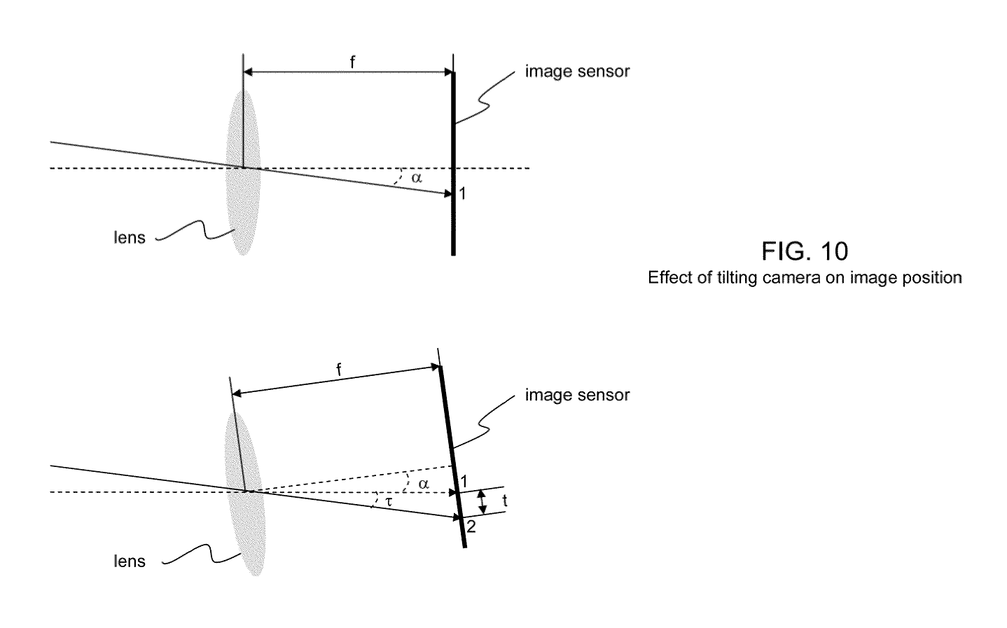

Shown in FIG. 9 is an image projected by the lens onto the image sensor. The image sensor has a width w and height h. In FIG. 10 we show a light ray impinging on the image sensor at position 1. When there is an angular tilt to the camera, the location of the light ray is changed to position 2. The distance between position 1 and 2 is given by:

t=f*tan(τ+α)−f*tan(α)

If the light ray was originally centered on the image sensor (i.e. α=0), then this expression simplifies to:

t=f*tan(τ)

This expression is valid for an angular deviation from the center of the image independent of whether it occurs in the vertical (tilt) or horizontal (yaw) direction. The same mathematical relationship can be used to determine the distance y (assuming α=0):

y=f*tan(ψ)

The above expressions are valid for an ideal projection lens. Other lens types will have different mathematical relationships between image sensor distances and angular changes in the camera direction. Also the maximum corrections that can be obtained will be limited by the angle of capture of the lens and the dimensions of the image sensor.

To obtain the desired image it is necessary to translate the center of the uncorrected field of view 602 by the distances t and y and roll by the angle ρ so that it aligns with the direction of gravity.

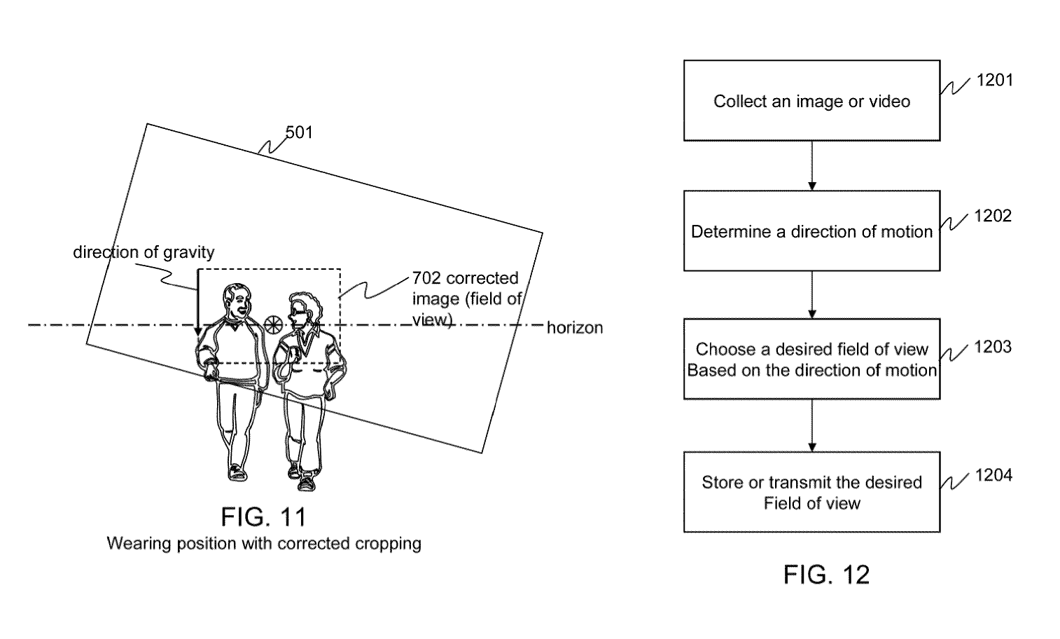

FIG. 11 illustrates desired portion 702 of image 501 taken from an improperly-oriented camera. Portion 702 has been chosen based on the three corrections mentioned above. Desired portion 702 has (1) its vertical edge aligned with the direction of gravity; (2) its center lies on the horizon; and (3) its center is aligned with the forward direction of the user. As is evident, because the desired field of view is corrected for variations resulting from user activity, any image collected from the camera is more likely to be pointed at a desired position.

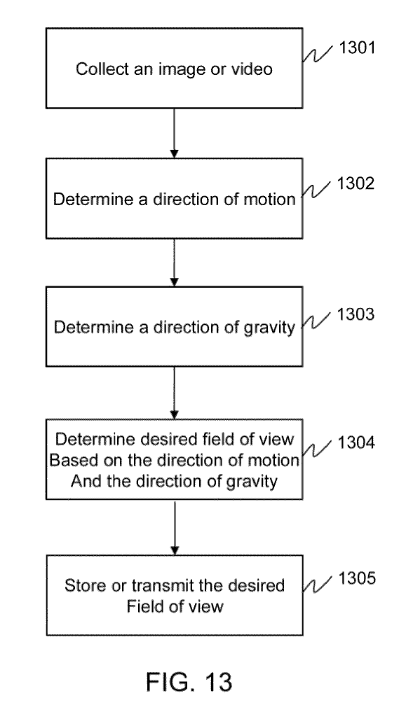

FIG. 12 is a flow chart showing the operation of the camera of FIG. 2 when choosing a desired field of view based on a direction of motion determined by an accelerometer. The logic flow begins at step 1201 where image collection circuitry 302 collects an image or video. As discussed above, the image or video collected is preferably a wide-angle image or video. Next, at step 1202 logic circuitry 301 determines a direction of motion from accelerometer 304. At step 1203, logic circuitry chooses the desired field of view (smaller than the field of view of the image collecting circuitry) from the image or video based on the direction of motion determined from the accelerometer. As discussed above the step of choosing the desired field of view from the image or video based on the direction of motion comprises the step of aligning the center of the desired field of view with a forward direction. Finally, at step 1204, the desired field of view may be stored, transmitted, or both.

FIG. 13 is a flow chart showing the operation of the camera of FIG. 2 when choosing a desired field of view based on a direction of motion and a direction of gravity determined by an accelerometer. The logic flow begins at step 1301 where image collection circuitry 302 collects an image or video. As discussed above, the image or video collected is preferably a wide-angle image or video having a first field of view. Next, at step 1302 logic circuitry 301 determines a direction of motion from accelerometer 304, and at step 1303 a direction of gravity is determined from accelerometer 304. At step 1304, logic circuitry determine the desired field of view (smaller than the first field of view) from the image or video based on the direction of motion and the direction of gravity determined from the accelerometer. As discussed above the step of choosing the desired field of view from the image or video based on the direction of motion comprises the step of aligning the center of the desired field of view with a forward direction, aligning a vertical edge of the desired field of view with the direction of gravity, and aligning a center of the desired field of view with a horizon. Finally, at step 1305, the desired field of view may be stored, transmitted, or both.

The corrections described above can be carried out in real time or may be carried out at certain intervals or implemented manually. One reason that real time corrections may not be desired, is that occasionally a user may bend over to look down or pick something up. It would be desirable to capture an image or video of this downward looking scene. However, if the corrections are made in real time, the corrected image will only be that of the horizon. To overcome this problem, the corrections can be implemented at selected intervals. For example, the logic circuitry can detect from the accelerometer that the user is in motion, and is therefore capable of triggering a correction to be made whenever the user is walking. Another alternative is to apply the correction only when the user manually instructs the device to make a correction. For example, the user could press a button or issue a voice command to make the correction.

While the invention has been particularly shown and described with reference to particular embodiments, it will be understood by those skilled in the art that various changes in form and details may be made therein without departing from the spirit and scope of the invention. For example, although the above description was given with regards to determining a desired field of view based on the direction of motion and the direction of gravity, it is intended that the desired field of view may be determined based solely on the direction of motion, or the direction of gravity. It is intended that such techniques come within the scope of the following claims:

1. A method for choosing a desired field of view from image or video, the method comprising the steps of:
collecting an image or video from image collecting circuitry;
determining a direction of motion from an accelerometer; and
choosing the desired field of view from the image or video based on the direction of motion determined from the accelerometer.

2. The method of claim 1 wherein the image or video collected is a wide-angle image or video.

3. The method of claim 1 wherein the desired field of view is smaller than the field of view of the image collecting circuitry.

4. The method of claim 1 further comprising the steps of transmitting the desired field of view.

5. The method of claim 1 further comprising storing the desired field of view.

6. The method of claim 1 wherein the step of choosing the desired field of view from the image or video based on the direction of motion comprises the step of aligning the center of the desired field of view with a forward direction.

7. The method of claim 1 further comprising the steps of:
determining a direction of gravity with the accelerometer; and
choosing the desired field of view from the image or video based on the direction of motion and the direction of gravity determined from the accelerometer.

8. The method of claim 7 wherein the step of choosing the desired field of view from the image or video based on the direction of motion and the direction of gravity comprises the steps of:
aligning a vertical edge of the desired field of view with the direction of gravity;
aligning a center of the desired field of view with a horizon; and
aligning the center of the desired field of view with a forward direction.

9. A method for choosing a desired field of view from image or video, the method comprising the steps of:
collecting an image or video from wide-angle image collecting circuitry having a first field of view;
determining a direction of motion from an accelerometer;
determining a direction of gravity from the accelerometer; and
choosing the desired field of view from the image or video based on the direction of motion and the direction of gravity determined from the accelerometer, wherein the desired field of view is smaller than the first field of view.

10. The method of claim 9 wherein the step of choosing the desired field of view from the image or video based on the direction of motion and the direction of gravity comprises the steps of:
aligning a vertical edge of the desired field of view with the direction of gravity;
aligning a center of the desired field of view with a horizon; and
aligning the center of the desired field of view with a forward direction.

11. An apparatus for choosing a desired field of view from image or video, the apparatus comprising:
image collecting circuitry collecting an image or video;
logic circuitry determining a direction of motion from an accelerometer and choosing the desired field of view from the image or video based on the direction of motion determined from the accelerometer.

12. The apparatus of claim 11 wherein the image or video collected is a wide-angle image or video.

13. The apparatus of claim 11 wherein the desired field of view is smaller than the field of view of the image collecting circuitry.

14. The apparatus of claim 11 further comprising a transmitter, transmitting the desired field of view.

15. The apparatus of claim 11 further comprising storage, storing the desired field of view.

16. The apparatus of claim 11 wherein the desired field of view is determined by aligning the center of the desired field of view with a forward direction.

17. The apparatus of claim 11 wherein the logic circuitry determines a direction of gravity with the accelerometer and chooses the desired field of view from the image or video based on the direction of motion and the direction of gravity determined from the accelerometer.

18. The apparatus of claim 17 wherein the logic circuitry chooses the desired field of view from the image or video based on the direction of motion and the direction of gravity by:
aligning a vertical edge of the desired field of view with the direction of gravity;
aligning a center of the desired field of view with a horizon; and
aligning the center of the desired field of view with a forward direction.
